(19) United States
(12) Patent Application Publication
(10) Pub. No.: US 2026/0023873 A1
(43) Pub. Date: Jan. 22, 2026

(54) METHODS AND SYSTEMS FOR GENERATING AND CONVERTING ROLE-SPECIFIC ELECTRONIC DOCUMENTS INTO POLYMORPHIC DOCUMENTS

(71) Applicant: Benjamin Louis Warshaw, Bloomingdale, GA (US)

(72) Inventor: Benjamin Louis Warshaw, Bloomingdale, GA (US)

(21) Appl. No.: 18/776,909

(22) Filed: Jul. 18, 2024

(51) Int. Cl. G06F 21/62; G06F 3/04845; G06V 30/14

(52) U.S. Cl. CPC G06F 21/6245; G06F 3/04845; G06V 30/1456; G06F 2221/2141

(57) ABSTRACT

In one aspect of the present disclosure, a method includes determining an electronic document to be secured for distribution to a distribution list. The method also includes selecting a first portion of the document to be associated with a first recipient from the distribution list. The method further includes generating a redacted electronic document. The first portion of the document is removed from the document. The method includes encrypting the redacted electronic document with an encryption key associated with the first recipient. Additionally, the method includes transmitting the redacted electronic document that was encrypted to a document management system for access by the first recipient from the distribution list.

### FIELD

The present disclosure relates to electronic document creation, editing, storage, and transmission.

### BACKGROUND

Document redaction is a process of editing a document to remove or obscure sensitive information before the document is shared or published. Typically, document redaction is used to protect personal identifiable information, privacy, maintain confidentiality, or comply with legal and regulatory requirements. Current software programs offer limited processes for securely redacting electronic documents. Conventionally, software programs redact an electronic document by generating a “black box” over portions of the document and exporting the document in a common file type, for example, Portable Document Format (PDF) or Open Document Format (ODF). Any recipient of the redacted document receives the same version with the same redacted portions with weak security infrastructure, governance, traceability, trackability, or completely devoid of reclamation that leads to leakage, unmasking exposure, hacking, that can lead to ransom attacks.

As can be seen, there is a need for electronic document redaction and security that addresses the above drawbacks.

### SUMMARY

The initial aspect of the present disclosure, the first step is to simply identify what segments need redaction then recipient inclusion assignment. This method includes and determines the electronic document distribution endpoints to one or several vetted recipients governed by the SDL (secure distribution list). The method includes selecting (by highlighting segments) portions of the document intended for the recipient(s) from the secure distribution list. Once completed, the method then auto-generates the redacted electronic child document to a designated recipient. The segmented portions of the document intended for recipient A for example are steganographic (completely removed) from recipient B's viewing privileges. The method includes encrypting the redacted electronic child document with an encryption key assigned to the first recipient. Once the parent document is finalized and ready for distribution, simultaneous processes, and policies are in play and governed only at the parent level. When the document is completed, the method first starts by automatically removing the parent document locally intact (from the workstation) and vaulting the parent onto cloud services while simultaneously transmitting a new child document per recipient which can only be accessed by each authorized recipient via a custom software viewer. A public child document with all notable redacted blacked-out elements can be toggled to autogenerated to comply with the Freedom of Information Act (FOIA) or Open Records Act.

### BRIEF DESCRIPTION OF THE DRAWINGS

FIG. 1 is a block diagram of a network environment including a document management system, according to aspects of the present disclosure;

FIG. 2 is a block diagram of a user device including a document management application, according to aspects of the present disclosure;

FIG. 3 is a process flow diagram of a document management method, according to aspects of the present disclosure;

FIG. 4 is a data flow diagram for the document management method of FIG. 3, according to aspect of the present disclosure;

FIG. 5 is an example of an interface generated by the document management application, according to aspects of the present disclosure; and

FIGS. 6A-6D are examples of documents generated by document management application, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a new document management application and secure distribution system that isolates, redacts or completely removes sensitive content directed from the parent level then redistributes child documents separately to each assigned recipient. The document management system and document management application can affect segmented objects within a parent document whether in whole, part, or as small as a single atomic unit otherwise known as an empty space, or single alphanumeric character. The “system” may include whole or layered images and object-linked and embedded data, otherwise known as OLE. The document management system and document management application use a repurposed highlighter intended to overload targeted objects within a parent document, for purposes of concealing (redacting) to everyone except the assigned recipient(s) which is controlled at the parent document level. Once the parent document is completed, children documents are autogenerated independently, paired and distributed wrapped with preset viewing and handling permission policies that govern each recipient independently. The parent and child documents are encrypted, managed and vaulted with cloud services. The secure distribution list (SDL) is a customized vetted contact list controlled and maintained independently by a licensed author who can selectively authorize access, elevate, restrict or revoke viewing permissions from any or all recipients; even after a document has been released, in transit or a rest.

The document management and application include a custom highlighter repurposed to overload (highlight) objects which works in tandem with the role-based assignment process that activates the custom contact management system known as the SDL (secure distribution list). Child document generation and distribution can only occur once the role-based assignment is validated through the SDL. The SDL is more than a secure contact manager. The SDL holds each recipient's trust profile, security level, MAC address, mailing address, latitude-longitude, recipient's email address, and time stamps all document events including read receipts back to the sender of the document. The SDL lets the author or sender appreciate if the recipient is active, or inactive. Any recipient or group without role-based assignment is labeled as public thus cannot see any redactions because those assigned portions are completely removed dynamically during the final children document generation process. If the children document requires public distribution due to an Open Records Act requirement, children documents will have notable traditional blacked-out areas where any redaction was used. Whether role-based assigned to trusted recipients or not, every parent document is deformed and reconstructed in a polymorphic state defined as a unique child document. Distribution of each child document can be sent immediately upon completion of the document or set as a calendar driven event to paired recipients from the SDL.

When overloading (highlighting) segmented objects (any portions of a document) the second step is concluded by selecting a recipient from the secure distribution. The recipient at this stage has a role. Recipient A for example is provided a role-based assignment from the author at the parent document level that will become a custom child document to recipient A once generated. Each role-based recipient is independently granted viewing access and handling permissions, consequently, other recipients may have more or less restrictions imposed by the author. The document management system and document management application autogenerates child documents for each recipient.

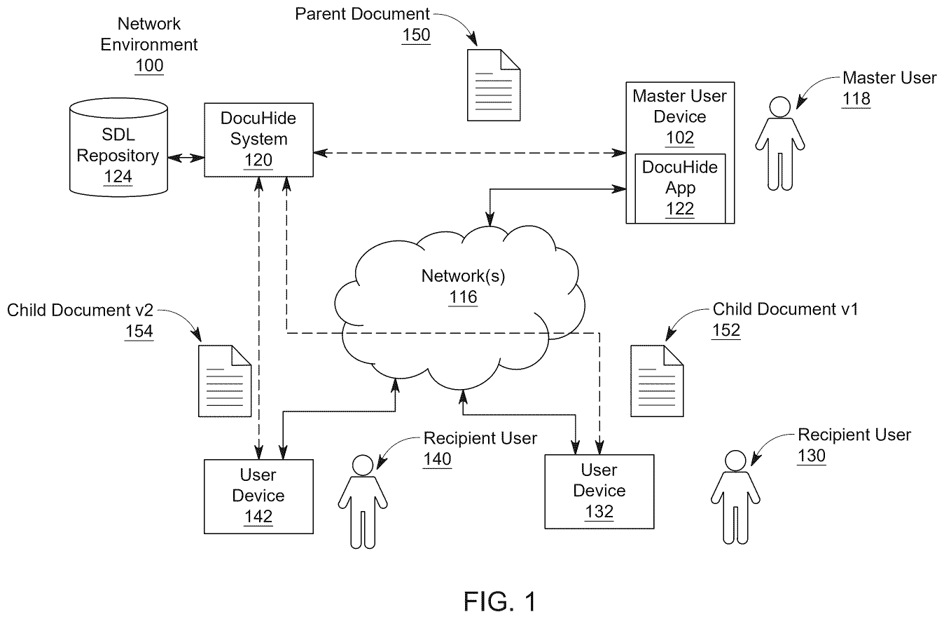

Referring now to FIG. 1, FIG. 1 illustrates a network environment 100 including a document management system 120 (also referred to as the Docuhide system 120) that operates with a document management application 122 (also referred to as the Docuhide application 122), according to aspects of the present disclosure. While FIG. 1 illustrates examples of components of the network environment 100, additional components can be added and existing components can be removed and/or modified.

As illustrated, the document management application 122 can be stored and executed on a master user device 102 that is operated by a user 118. The master user device 102 can communicate with the document management system 120 via one or more networks 116. The document management system 120 can also communicate with other users, e.g., a recipient user 130 and a recipient user 140, via the network 116, which are operating other user devices, e.g., a user device 132 and a user device 142.

In embodiments, the document management application 122 and the documents management system 120 operate together to save, secure, and modify a parent document 150 and generate one or more child documents, e.g., child document 152 and child document 154. The document management application 122 and the documents management system 120 enable sensitive content to be identified from the parent document 150 and then redacted in the child documents, e.g., child document 152 and child document 154. The document management application 122 generates a graphical user interface that allows the master user 118 to view the parent document 150 and select portions of the parent document 150 using a highlighter tool. The highlighter tool allows the master user 118 to assign specific areas within a parent document 150, which will be governed by a digital rights manager that prohibits or allows how a document is used, to when a document seen or discontinued. The document management application 122 utilizes a role-based assignment process that activates the custom contact management system known as the SDL (secure distribution list). Child document generation and distribution can only occur once the role-based assignment is validated through the SDL. The SDL is more than a secure contact manager. The SDL holds each recipient's trust profile, security level, MAC address, mailing address, latitude-longitude, recipient's email address, and time stamps all document events including read receipts back to the sender of the document. The SDL lets the author or sender appreciate if the recipient is active, or inactive.

The highlighter tool overloads (specific highlighted content) targeted objects for purposes of role-based assignment thus revealing visible content only to intended recipients known as child documents, e.g., child document 152 and child document 154. The child documents are autogenerated from the parent document 150 based on the number of recipients as instructed from the parent document making each child document an efficient one-to-one deliverable. All other recipients are intentionally excluded from the selected, highlighted, segments (content) and cannot see that particular content from the parent document 150 as it has been modified and redistributed as a child document assigned to that specified recipient.

For example, the master user 118 can select a portion of the parent document 150 with the highlighter tool and assign the selected portion to recipient user 130. In response, the child document 152 can be generated and access can be provided to the recipient user 130, via the user device 132. In the child document 152, the selected portion is deleted from the document and does not appear in the child document 152. Due to the rights management, only the user, e.g., the recipient user 130, assigned to the selected portion has access to the child document 152.

Additionally, the document management application 122, via the document management system 120, provides control over the child document 152, for example, editing the child document 152, sharing the child document 152, deleting the child document 152, placing a “time to live” (expiration time) on the child document 152, increasing access to the child document 152, and the like. The same process can be performed for the child document 154, which can be assigned to recipient user 140.

Additionally, the document management application 122 and the document management system 120 can generate a consolidated version of the parent document 150 in which any highlighted objects are obscured. The document management application 122 and the document management system 120 can control access to the consolidated version using right management and encryption.

In embodiment, the parent document 150 and the child documents, e.g., child document 152 and child document 154, can be securely stored in the secure distribution list (SDL) repository 124. The parent document 150 can be encrypted with an encryption key of the master user 118, which can be maintained on the master user device 102. The child document 152 and the child document 154 can be encrypted with encryption keys that are provided to the recipients. Access the child documents, e.g., child document 152 and child document 154, can be controlled by the assignment and revocation of the encryption keys and the rights management.

By highlighting (overloading) or segmenting the desired objects in the parent document, either containing content, spaces, images, or any embedded media, those objects are then assigned to unique recipients, e.g., the recipient user 130 and/or the recipient user 140. The document management application 122 autogenerates children documents, e.g., child document 152 and child document 154, for each targeted recipient, e.g., the recipient user 130 and/or the recipient user 140. The document management system 120 redistributes, based on the unique rules governing for each recipient, newly formed child documents matching each recipient via the SDL repository 124, which in turn provides authorized access thus revealing the modified selected content objects.

As described herein, any word and/or single alphanumeric character, which including a space, whole or layered images and object linked and embedded data, technically known as a single atomic unit, can be built in a hierarchy when the parent document 150 is complete. Every object can be decomposed from a word or sentence into a new child object when any document is overloaded for redaction purposes. The child documents, e.g., child document 152 and child document 154, can then exist in a polymorphic object state reflecting the document has already been assigned and ready for distribution, for example, to the user device 132 and/or the user device 142.

As used herein, in the context of documents, a “polymorphic object” typically refers to an element within the document, e.g., the parent document 150, that can change its appearance or behavior under different conditions. This term, while not commonly used in straightforward document design, can be interpreted through the lens of document security or digital document formats. Here's a deeper. For physical documents, a polymorphic object could be a security feature that exhibits different characteristics under various conditions. One example can be an ink that changes color based on temperature or angle of view, often used in banknotes and other high-security documents to prevent counterfeiting. Another example can be watermarks that appear only under UV light or from certain angles. These are hidden features that can validate a document's authenticity when exposed to specific conditions.

In digital documents, polymorphism might manifest in features that adapt based on user interaction or the software environment. On example can involve adaptive content. A document can display different content based on the user's access rights. For example, a PDF file might show additional details to users with administrative permissions while presenting only basic information to standard users. Another example can include responsive design elements. Similar to responsive web design, a digital document might alter its layout and content presentation depending on the device it is viewed on (e.g., desktop, tablet, or smartphone).

From a programming perspective, the term “polymorphic” can be used to describe objects in object-oriented programming that can process data differently depending on their type or class. In software that handles documents, such as a document management system, polymorphic methods could be used to handle different types of documents (like PDFs, Word files, and HTML pages) through a single interface, with each document type responding differently to common operations like redaction, saving, or encrypting. For example, imagine a document management software where “Document” is a base class with a method called display ( ). There could be multiple subclasses like PDF Document, Word Document, and HTML Document each implementing the display ( ) method differently to accommodate their specific redaction needs. This polymorphism allows the software to handle various document types dynamically, adapting its functionality to the specific requirements of each document type.

As such, “polymorphic object” provides versatility and adaptability, enabling documents to change to be more secure and interactive based on the environment and user interaction.

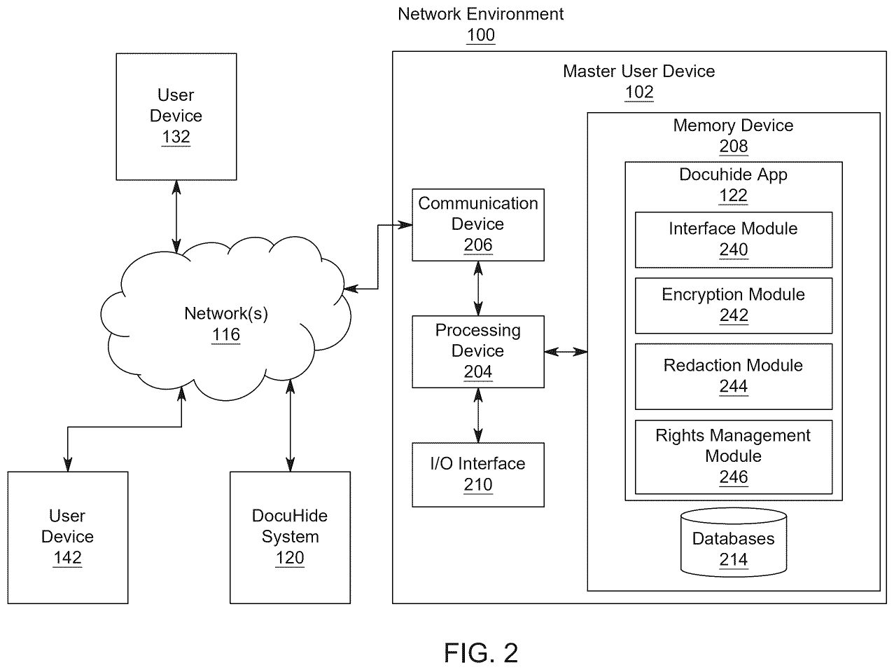

As illustrated in FIG. 2, the master user device 102 includes a processing device 204 coupled to a communication device 206. The processing device 204 is also coupled to a memory device 208, and an input/output (“I/O”) interface 210. In embodiments, the communication interface 206 enables the master user device 102 to communicate with other devices and systems via one or more networks 116. The master user device 102 can communicate with the document hide system 120, the user device 132 and the user device 142, via the networks 116. The user devices 132 and/or 142 can include one or more electronic devices such as a laptop computer, a desktop computer, a tablet computer, a smartphone, a thin client, and the like. The document management system 120 can include one or more server computers and or cloud computing systems as described below.

According to the aspects of the present disclosure, the master user device 102 can store and execute a copy of the document management application 122. The document management application 122 enables the master user 118 operating the master user device, to perform the methods and process described herein. the document management application 122 can include an interface module 240, and an encryption module 242, a redaction module 244, and a rights management module 246 to perform the processes and methods described herein. The document management application 122 including the modules can be stored in the memory device 208. The document management application 122 including the modules can include the necessary logic, instructions, and/or programming to perform the processes and methods described herein. The document management application 122 can be written in any programming language.

The memory device 108 can also include a database 114 that stores information and data associated with the process and methods described herein. The database 114 can store data for operating and communicating with the document management system 120. The database 114 can also include a secure data store that stores encryption keys used by the encryption module 242 The database 114 can be any type of database, for example, a hierarchical database, a network database, an object-oriented database, a relational database, a non-relational database, an operational database, and the like.

The interface module 240 operates to generate and provide graphical user interfaces (GUIs) to the document management application 122, for example, menus, widgets, text, images, fields, etc. The GUIs generated by the interface module 140 can be interactive. In embodiments, the interface module 240 can generate one or more document management interfaces that include a highlighter tool. The highlighter tool allows the master user 118 to assign specific areas within a parent document 150, which will be governed by a digital rights manager that prohibits or allows how a document is used when a document is seen or discontinued. The highlighter tool overloads (specific highlighted content) targeted objects for purposes of role-based assignment thus revealing visible content only to intended recipients known as child documents, e.g., child document 152 and child document 154.

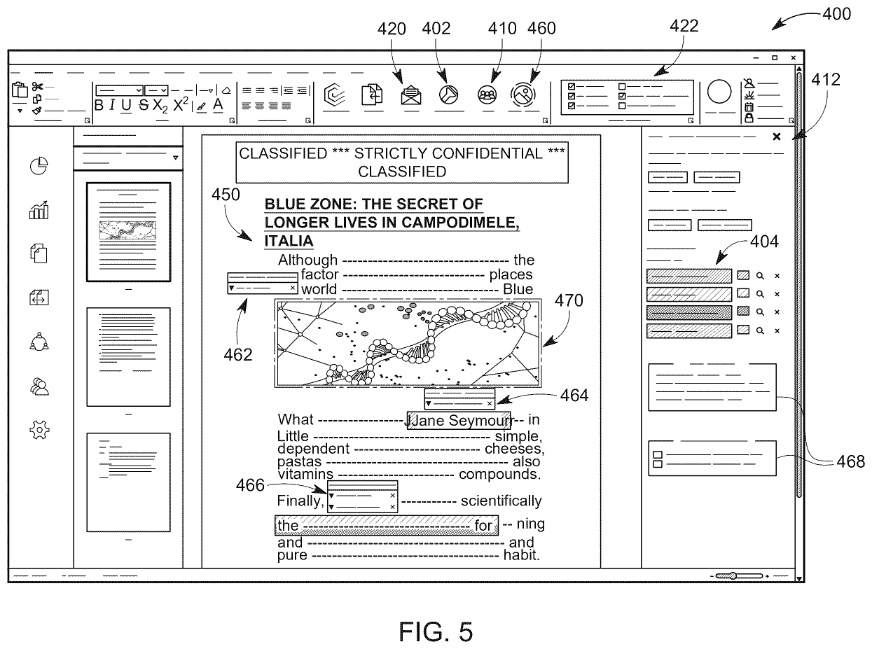

For example, FIG. 5 illustrates an example of a GUI 400 that generated by the document management application 122. As illustrated in FIG. 5, the GUI 400 can include a highlighter tool 402 (Hidelighter). The highlighter tool 402 can utilize different coloring highlighting to select different polymorphic objects in document 450 being displayed. Each color can be assigned to one or more recipients in an SDL and controlled using an SDL menu interface 404. That is, each person in an SDL can be associated with a particular color that is used to highlight portions of the document 450. The highlighted portions will be associated with the policy rules and roles of the associated recipients in the SDL. When a child document is created, the policy rules and roles will be applied to the highlighted portion of the document 450. The GUI 400 can also include a hide image widget 460 that allows images, e.g., image 470, in the document to be assigned policy rules and roles.

Once a portion of the document 450 has been highlighted with the highlighter tool 402, the portion can include metadata that display a popup menu, when a cursor is placed over the text, e.g., a popup menu 462 associated with the image 470 selected, a popup menu 464 associated with the highlighted text “Jane Seymour”, and a popup menu 466 associated with other text. The popup menu can display the name and other information of recipients in the SDL that are associated with the highlighted portion.

The SDL menu interface 412 can be accessed using a secure distribution widget 410. The GUI 400 can include a color pane 404 that offers preselected safe colors is encouraged not to obscure reading for the author or recipients. The color pane can include a built-in color configurator that provides accurate HTML codes as well as RGB values should the Author create custom Hidelighter colors for redaction. The GUI 400 can include hover over widget controlling a hover over function. The hover over function can be active by default unless turned off. Hover allows master user 118 to quickly reference recipients assigned to the modified (redacted) objects when the pointer is placed over modified objects when the parent document 450 is open, as demonstrated in the figure below. First and last name with parentheses may include and indicate recipient(s) either individually (i) or as part of a group (G).

The secure distribution widget 410 activates the SDL menu interface 412 and sub-menus. Using the SDL menu interface 412 and sub-menus, the master user 118 can select recipients to be associated with colors for the highlighter 402. The master user 118 selects and assigns the redacted segments to specific recipient from the secure distribution list. The secure distribution list controlled by the master user 118 or system administrator. Profiles of any recipient can be edited to either elevate, restrict, or revoke reading authority. Each profile inside the SDL displays personal information about the contact and keeps track of the number of documents each contact/recipient was sent. The GUI 400 can also include a send widget 420 that initiates generation of child documents and the encryption processes. The GUI 400 also include a policy menu 422 that allows the master user 118 to select and restrict or allow permissions to the recipient, for example, the ability to print a document or remove the ability to print, the ability or restrict copying all or part of a document, a time to live for the child document, etc.

The GUI 400 can include other menus and boxes 468 that display other information associated with the document 450 such as an SDL ledger that display the recipients in the SDL and information (e.g., email address) and an annotation ledger that display users that have made an annotations.

In embodiments, the encryption module 242, the redaction module 244 and the right management (DRM) module 246. The encryption module 242 is configured to implement asymmetric and symmetric encryption algorithms and manage keys for the encryption module. When the parent document 150 is imported into the document management application 122, the encryption module 242 can encrypt the document for storage in the SDL repository. Public key architecture umbilically binds the recipient (reader) to the children document policies set forth by the author. Encryption, Authentication, and Integrity is maintained via the TLS protocol which is designed to provide three essential services when writing, in transit at rest or when reading or signing documents. Session identification sends a checksum or refresh signal from the server to validate user attendance or in case of a last-minute revocation whereby the recipient or user's rights are removed resulting in their session ending abruptly.

The redaction module 244 can be configured to control the editing of the parent document 150 and the generation of child documents, e.g., the child document 152 and child document 154. The redaction module 244 can be configured to segment and overload objects in part or whole within any electronic document, or email, whether containing single to multiple images, including embedded documents or containing video, audio or XHTML Extensible Hypertext Markup Language (XHTML) viewed through any browser or supporting associative office related application by using our drawing mechanism. Object segmentation and modification allows the master user 118 to create the parent document 150 while taking a granular approach to overloading newly modified objects to be individually stored as a unique set of rules and paired to independent recipients for distribution for viewing. A child document per designated recipient e.g., the child document 152 and child document 154, can be newly formed which becomes a polymorphic object. A secure one-to-many digital relationship with discretionary transparency with permission viewership level in a single transaction becomes a reality.

The DRM module 246 is configured to control the rights management of the child documents. Readers and group recipients who do not have clearance to view redacted or modified object areas of the child document e.g., the child document 152 and child document 154 will not observe or know what they are missing because the assignment to the modified objects (content) can be optionally shored up, leaving no white spaces or gaps. The DRM module 246 utilizes a role-based assignment process that activates the custom contact management system known as the SDL. Child document generation and distribution can only occur once the role-based assignment is validated through the SDL. The SDL is more than a secure contact manager. The SDL holds each recipient's trust profile, security level, MAC address, mailing address, latitude-longitude, recipient's email address, and time stamps all document events including read receipts back to the sender of the document. The SDL lets the author or sender appreciate if the recipient is active, or inactive.

Document(s) are distributed over a secure connection from the document management application 122. Once the master user 118 imports the desired document into the document management application 122 and commences the redaction process, the imported document now becomes the parent document 150. Each recipient assignment from the SDL can be uniquely tethered to the newly modified objects (redacted content), and with each recipient, independent rules and color legend are created, which is maintained by the DRM module 246. The master user 118 can impose policies governed by the SDL (Secure Distribution List) that may include mandatory reading attendance or no print notification. The rule set for each recipient can dynamically and simultaneously manufactures a child document for distribution. Upgrading user status or reassigning, revoking privileges, or user status can be changed before or post sending redacted documents. As such, the master user 118 can identify and keep track of the recipients.

The redaction module 244 can control the highlighting tool to overload any text or image otherwise known as a newly modified object within the initial parent document for concealment reasons. Each dynamically converted child document from the parent would have already had recipient assignment and encryption. The master user 118 can impose policies governed by the SDL (Secure Distribution List) that may include mandatory reading attendance or no print notification. Upgrading user status or reassigning, revoking privileges, or user status can be changed before or post sending redacted documents.

Document policy may allow for a TTL (Time to Live), be destroyed in transit or at rest, or removed immediately after a user has closed the document thus ending the session. Audit trailing or blockchain tracks who, when, and how long a document was observed or if the document was never opened. IP Address, Device Type, MAC Address and/or LAT LONG (Location) are optional levels for tighter user authentication.

The master user 118 may create, edit, import contacts, and organize via the SDL by providing a category name and assign any color. Color assignment is applied to a single user, or group. Trust Factoring a feature inside the SDL whereby the administrator or author may assign a numerical 1-5 (one through five) value to determine a user's clearance level. Permission can be upgraded or downgraded any time. Policy determines who is allowed to read the redacted portions of the document(s) and who are not, including but not limited to the style of the redaction. Readership time-stamp validation is reconciled via the SDL. The SDL is customizable to each administrator or author (master user) for its role is to maintain profiles of each user and clearance level. Policy assignment is at the discretion of administration or author.

The master user 118 can choose from preset preamble notification to the reader or receiving parties regarding terms, conditions and policies governing the document or instrument prior to viewing. Example, “For Your Eyes Only”, “Classified”, “Confidential” Failure to adhere to the policies herein may result. A method for sending one digital document to unlimited recipients containing sensitive modified objects (content) which can only to be revealed to select groups or individuals who have been identified by the author who thereby grants whole or limited access through role-based distribution governance called the SDL.

The DRM module 246 can be configured to control Access methodology for viewing newly formed objects or children documents is conducted at the administration level by using the SDL whereby recipients are selected then assigned via invitation to view their child document. Authorship controls the policies for permission-level readership for:
1. Individual or group assignment of users whether in an isolated or collaborative environment
2. Document Audit Trail to blockchain timestamps document travel of reader participation, activity or non-activity
3. DRS—Digital Rights Management issued to all “readers” which hold permission levels maintained by the SDL (Secure Distribution List) and policy features when opened outlines author's position and document function and limitations.
4. Checksum security services continue run in the background and refreshes user's credentials
5. Document access may include matching Device Type, MAC Address, IP Address, Latitude & Longitude while document is active or in session.
6. Readership Revocation at any time.
7. Document Destruction at any time.
8. Document Time to Live (TTL) imposed prior to sending.
9. Permission level control either upgrading or downgrading accessibility.
10. Color demarcation redacted areas
11. Intentionally hiding (blackout) redacted areas
12. Shore Up or remove gaps within the document.
13. Document delineation: Assigning specific (delineated) modified areas of a document to multiple, individual or group.

In the above description, various functionality of the process is described as being performed by the document management application 122 and modules. In any embodiment, the functionality can be performed by the document management system 120.

The processing device 204, the communication device 206, the memory device 208, and the I/O interface 210 can be interconnected via a system bus. The system bus can be and/or include a control bus, a data bus, an address bus, and the like. The processing device 204 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 2 illustrates a single processing device 204, the master user device 102 can include multiple processing devices 204, whether the same type or different types.

The memory device 208 can be and/or include one or more computerized storage media capable of storing electronic data temporarily, semi-permanently, or permanently. The memory device 208 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 208. While FIG. 2 illustrates a single memory device 208, the master user device 102 can include multiple memory devices 208, whether the same type or different types.

The communication device 204 enables the master user device 102 to communicate with other devices and systems. The communication device 204 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wi-Fi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a Wi-Fi connection where data is passed through a Wi-Fi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long-term evolution (“LTE”) standard, and so forth.

The master user device 102 can communicate with one or more network resources via the network 116. The one or more network resources can include external databases, social media platforms, search engines, file servers, web servers, or any type of computerized resource that can communicate with the master user device 102 via the network 116.

In embodiments, the components and functionality of the master user device 102 and/or the document management system 120 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the master user device 102 and/or the document management system 120 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the master user device 120 can include a user interface for outputting information in a format perceptible by a user and receiving input from the user. For example, the master user device 102 can communicate with the user interface via the I/O interface 112. The user interface can display GUIs generated by the master user device 102 and/or the document management system 120. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

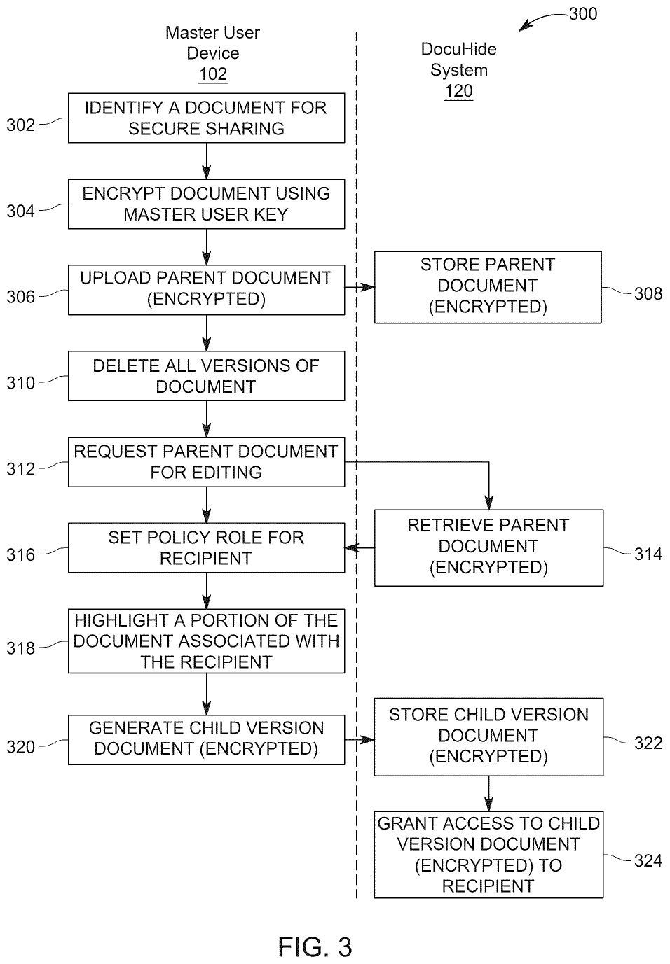

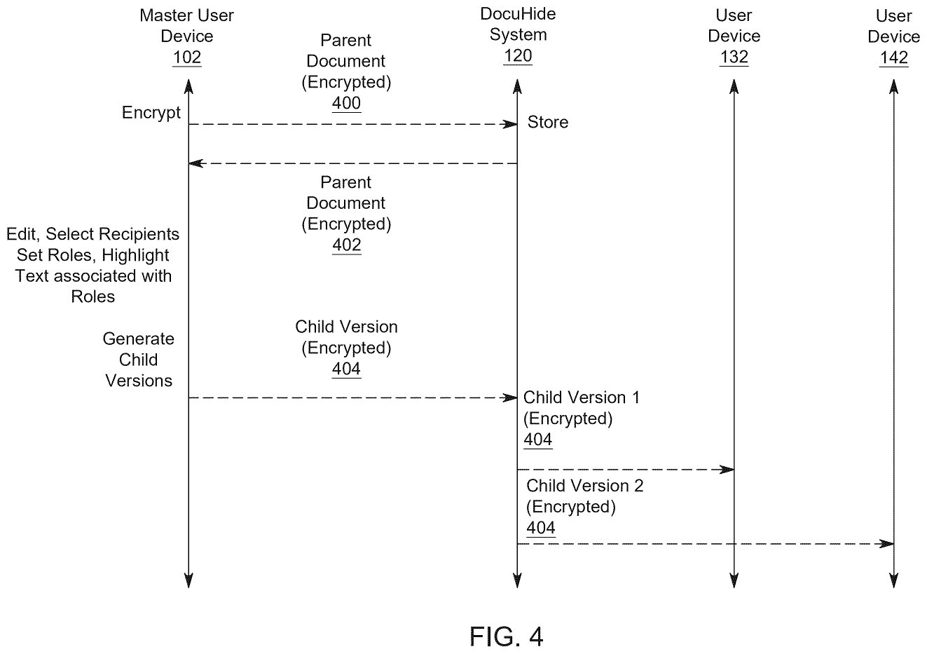

FIG. 3 illustrates a method 300 for document management, according to aspects of the present disclosure. FIG. 4 illustrates the data flow in the method 300, according to aspects of the present disclosure. While FIG. 3 illustrates various stages of the method 300, additional stages can be added and existing stages can be removed and/or reordered.

At stage 302, a document for sharing can be identified. At stage 304, the document can be encrypted using the master user key and transmitted to the document management system 120, at stage 306. At stage 308, the document management system 120 can store the parent document, which was encrypted. At stage 310, the parent document can be removed from the master user device.

For example, the master user 118 can select a document stored on the master user device 102 and/or upload an electronic document to the master user device 102. The document management application 122 can then encrypt the document to create the parent document 150. The parent document 150 can then be transmitted to the document management system 120 for storage in the SDL repository, and all version can be removed from the master user device 102.

In stage 312, the parent document can be requested for editing. In stage 314, the parent document can be retrieved and transmitted to the master user device. For example, when the master user 118 is ready to redact a document, the document management application 122 can request the parent document 150 from the document management system, which is then transmitted to the master user device 102.

In stage 316, a policy role can be set for a recipient. In stage 318, a portion of the document can be highlighted. Once all edit and highlights have been made, in stage 320, the child version of the document can be generated and encrypted. For example, the document management application 122 can generate the child document. In stage 322, the child document can be returned to the document management system along with metadata and policy roles. In embodiment, the parent document 308 can be returned or checked into the document management system. In stage 324, the child version of the document can be made available to the recipient. In some embodiments, the generation and/or encryption of the child document can be performed by the document management application 120.

For example, the document management application 122 generates a graphical user interface that allows the master user 118 to view the parent document 150 and select portions of the parent document 150 using a highlighter tool. The highlighter tool allows the master user 118 to assign specific areas within a parent document 150, which will be governed by a digital rights manager that prohibits or allows how a document is used when a document is seen or discontinued. The highlighter tool overloads (specific highlighted content) targeted objects for purposes of role-based assignment thus revealing visible content only to intended recipients known as child documents, e.g., child document 152 and child document 154. The child documents are autogenerated from the parent document 150 based on the number of recipients as instructed from the parent document making each child document an efficient one-to-one deliverable. All other recipients are intentionally excluded from the selected, highlighted, segments (content) and cannot see that particular content from the parent document 150 as it has been modified and redistributed as a child document assigned to that specified recipient.

The master user 118 can select a portion of the parent document 150 with the highlighter tool and assign the selected portion to recipient user 130. In response, the child document 152 can be generated and access can be provided to the recipient user 130, via the user device 132. In the child document 152, the selected portion is deleted from the document and does not appear in the child document 152.

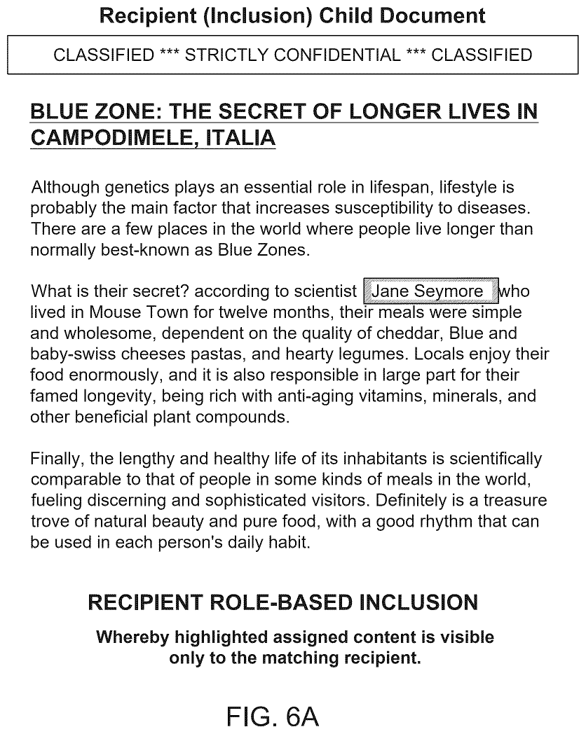

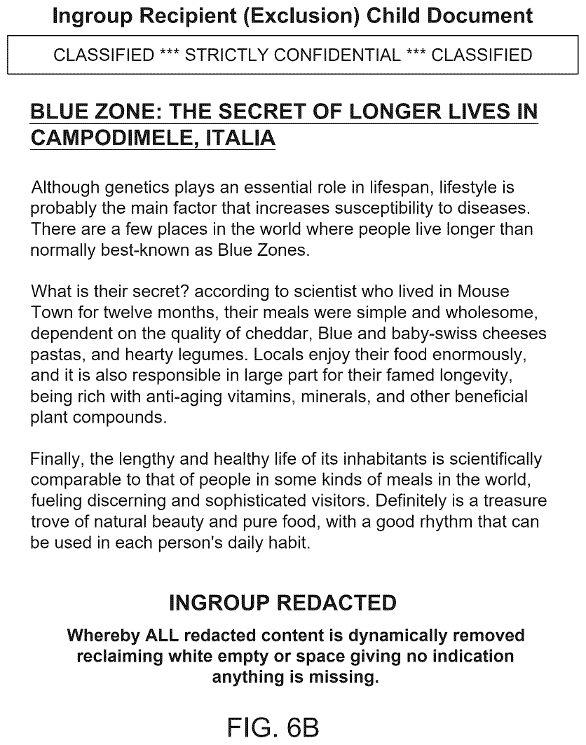

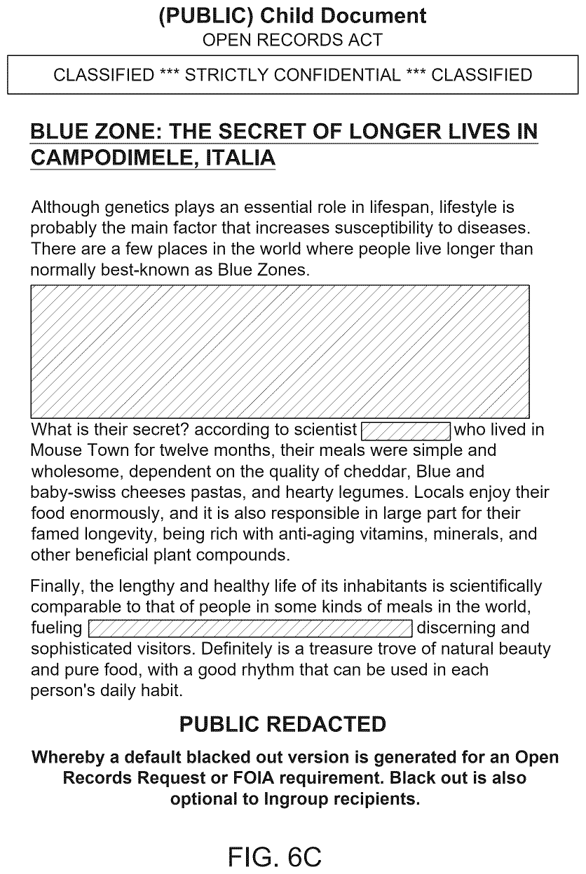

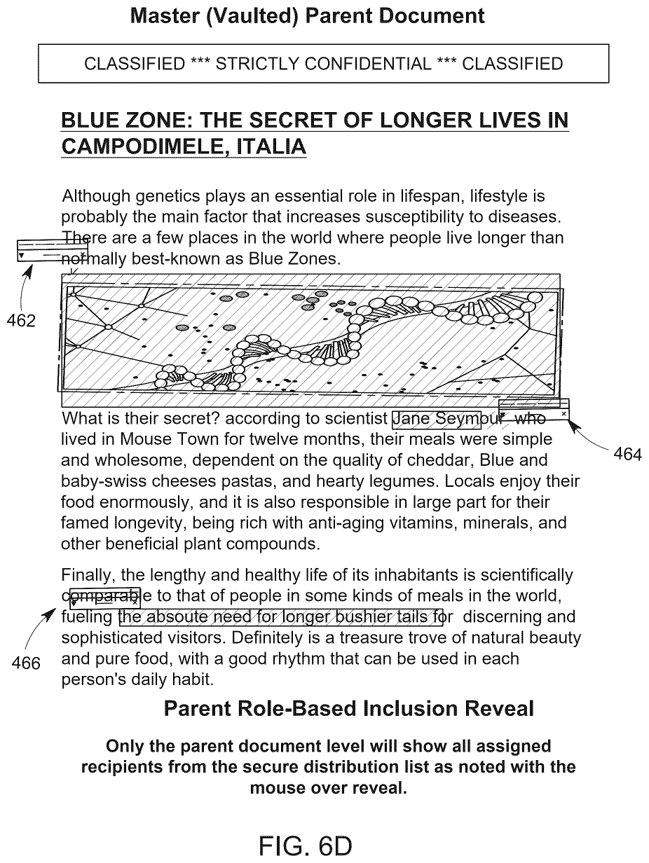

FIGS. 6A-6D illustrate examples of comparisons of parent documents and child documents. For example, as illustrated above in FIG. 5, the master user 118, in the parent document 450, highlights and assigns readership permission to different receipts in the SDL using the highlighter. The parent document 450 in the GUI 400 can be newly generated or imported. The master user 118 imposes viewing assignment and permission levels. The master user 118 assigns post document handling includes isolated revocation, privilege elevation, and document detonation. The child documents can be generated.

In the example of FIG. 6A, the master user 118 assigns a receipt role-based inclusion policy. In this policy, highlighted assigned content is visible ONLY to the matching recipient. In the example of FIG. 6B, the master user 118 can assign an in-group exclusion redacted policy. In this policy, in the child document, all redacted content is dynamically removed reclaiming white empty or space giving no indication anything is missing. In the example of FIG. 6C, the master user 118, in the parent document 150, can invoke a public redacted copy. The document management application 122 automatically redacts all highlighted areas shown in blackout or can remove those passages altogether. For example, a blacked-out version is generated for an Open Records Request or FOIA requirement. Black out can also optional to Ingroup recipients.

Due to the rights management, only the user, e.g., the recipient user 130, assigned to the selected portion has access to the child document 152. Additionally, the document management application 122, via the document management system 120, provides control over the child document 152, for example, deleting the child document 152, placing a “time to live” (expiration time) on the child document 152, increasing access to the child document 152, and the like.

FIG. 6D illustrates the Master “vaulted parent” document. This is the document that is removed from the master user 118 computer device and stored/vaulted on the document management system 120. Every time the master user 118 edits any document, version control is auto-enabled and a time stamp is issued. There's an audit trail every time anyone (master user and/or recipient user) touches a document. Only the Master “vaulted parent” document level will show all assigned recipients from the secure distribution list as noted with the mouse over reveal, e.g., popup menus 462, 464, and 466.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the element's A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method, comprising:
determining an electronic document to be secured for distribution to a distribution list;
selecting a first portion of the document to be associated with a first recipient from the distribution list;
generating a redacted electronic document, wherein the first portion of the document is removed from the document;
encrypting the redacted electronic document with an encryption key associated with the first recipient; and
transmitting the redacted electronic document that was encrypted to a document management system for access by the first recipient from the distribution list.

2. The method of claim 1, further comprising:
selecting a second portion of the document to be associated with a second recipient from the distribution list;
generating a second redacted electronic document, wherein the second portion of the document is removed from the document;
encrypting the second redacted electronic document with an second encryption key associated with the second recipient; and
transmitting the second redacted electronic document that was encrypted to the first recipient from the distribution list.

3. The method of claim 2, further comprises:
generating a third redacted electronic document that includes an obscured version of the first portion and the second portion.

4. The method of claim 1, wherein selecting the first portion of the document to be associated with a first recipient from the distribution list comprises:
displaying a copy of the electronic document in a graphical user interface, the graphical user interface comprising a highlighting tool for selecting portions of the electronic document;
receiving user input controlling the highlighting tool to select the first portion of the document; and
generating a reference to the first portion of the document selected.

5. The method of claim 4, further comprising:
receiving a user selection of a color of the highlighting tool to be associated with the first recipient from the distribution list.

6. The method of claim 1, further comprising:
receiving user input to remove access to the redacted electronic document from the first recipient; and
cryptographically disabling access of the first recipient to the redacted electronic document.

7. A computer-readable medium storing instructions for causing a processing device to perform a method, the method comprising:
determining an electronic document to be secured for distribution to a distribution list;
selecting a first portion of the document to be associated with a first recipient from the distribution list;
generating a redacted electronic document, wherein the first portion of the document is removed from the document;
encrypting the redacted electronic document with an encryption key associated with the first recipient; and
transmitting the redacted electronic document that was encrypted to a document management system for access by the first recipient from the distribution list.

8. The computer-readable medium of claim 7, wherein selecting the first portion of the document to be associated with a first recipient from the distribution list comprises:
displaying a copy of the electronic document in a graphical user interface, the graphical user interface comprising a highlighting tool for selecting portions of the electronic document;
receiving user input controlling the highlighting tool to select the first portion of the document; and
generating a reference to the first portion of the document selected.

9. The computer-readable medium of claim 8, wherein the method performed by the processing device further comprises:
receiving a user selection of a color of the highlighting tool to be associated with the first recipient from the distribution list.

10. The computer-readable medium of claim 7, wherein the method performed by the processing device further comprises:
receiving user input to remove access to the redacted electronic document from the first recipient; and
cryptographically disabling access of the first recipient to the redacted electronic document.
